(19) United States
(12) Patent Application Publication
(10) Pub. No.: US 2026/0244686 A1
(43) Pub. Date: Aug. 20, 2026

(54) SYSTEM AND METHOD FOR THE IDENTIFICATION AND EVALUATION OF BOTH HUMAN AND ARTIFICIAL INTELLIGENCE GENERATED CLAIMS

(71) Applicant: Battelle Memorial Institute, Columbus, OH (US)

(72) Inventors: Jeremy BELLAY, Columbus, OH (US); Jeffrey J. GEPPERT, Columbus, OH (US); Gerrit BRYAN, Columbus, OH (US); Chun Lin LIU, Columbus, OH (US); Stephen A. BOXWELL, Worthington, OH (US); Callie DEAS, Worthington, OH (US); Tim Liu, Lake Stevens, WA (US)

(21) Appl. No.: 19/534,941

(22) Filed: Feb. 10, 2026

Related U.S. Application Data
(60) Provisional application No. 63/758,410, filed on Feb. 14, 2025.
(60) Provisional application No. 63/876,361, filed on Sep. 5, 2025.

(51) Int. Cl. G06F 16/901; G06F 16/93; G06N 20/00; G06Q 40/08

(52) U.S. Cl. CPC G06F 16/9024; G06F 16/93; G06N 20/00; G06Q 40/08

(57) ABSTRACT

In an approach to identification and evaluation of generated claims, a system includes a computing device; an AI engine; a database; and program instructions to: receive measure documents; extracted claims and evidence; create a set of total claims from the received extracted claims; for each of the total claims: identify potentially relevant evidence from the database using the AI engine; for each of the potentially relevant evidence: evaluate a quality and a confidence level; for each of the total claims: determine whether each of the potentially relevant evidence supports each of the total claims; evaluate a claim status for each individual claim based on the quality and the confidence level of the potentially relevant evidence, and whether the potentially relevant evidence supports the individual claim; and evaluate the measure documents based on the total claims and the claim status of each of the total claims related to the measure document.

### CROSS-REFERENCE TO RELATED APPLICATIONS

The present application claims the benefit of the filing date of U.S. Provisional Application Ser. No. 63/758,410, filed Feb. 14, 2025, and U.S. Provisional Application Ser. No. 63/876,361, filed Sep. 5, 2025, the entire teachings of which applications are hereby incorporated herein by reference.

### STATEMENT REGARDING FEDERALLY SPONSORED RESEARCH OR DEVELOPMENT

This invention was made with government support under contract number 75FCMC23C0010 awarded by the United States Department of Health and Human Services Centers for Medicare & Medicaid Services. The government has certain rights in the invention.

### TECHNICAL FIELD

The present disclosure relates generally to a system and method for the identification and evaluation of both human and artificial intelligence generated claims.

### BACKGROUND

In the field of evaluation of both human and artificial intelligence (AI) generated content, it is important to assure trustworthy quality measures. Identifying, assessing, and summarizing literature is time and resource intensive. The goal is to make the evidence explicit and explicitly evaluate that evidence, and to guard against the potential for “confirmation bias,” i.e., the tendency to process and interpret information in a manner that is consistent with existing beliefs.

A typical approach to evaluate content, claims are analyzed and “assurance cases” are constructed to validate the claims. These claims may be generated by a measure developer and/or from an AI source, such as ChatGPT. Evidence in support of claim, including expertise, experience, logic, empirical, computational, simulation, engineering, is gathered and an argument (why the evidence supports claim) is compiled. This may be through logical inference, such as deduction, induction, or abduction (inference to the best explanation).

Measure developers and/or measure stewards make certain explicit or implicit assertions or claims about the potential benefits and risks/harms associated with measure use (net benefit). As used herein, the term measure steward means any signatory authorized person within an organization. Currently the identification and assessment of claims is a manual process that is both time and resource intensive and subject to confirmation bias. There exists a need to automate the process of identification and assessment of claims.

### BRIEF DESCRIPTION OF THE DRAWINGS

Reference should be made to the following detailed description which should be read in conjunction with the following figures, wherein like numerals represent like parts.

FIG. 1 is a functional block diagram illustrating a distributed data processing environment consistent with the present disclosure.

FIG. 2 is a table of a measure evaluation of a status of a claim consistent with the present disclosure.

FIG. 3A is a table of a measure evaluation of quality levels of evidence consistent with the present disclosure.

FIG. 3B is a table of a measure evaluation of confidence level of evidence consistent with the present disclosure.

FIG. 4 is a table of a measure evaluation of endorsability of a document consistent with the present disclosure.

FIG. 5A is an example data flow diagram for the identification and evaluation of both human and artificial intelligence generated claims consistent with the present disclosure.

FIG. 5B is an example database schema diagram from the data flow diagram of FIG. 5A for the identification and evaluation of both human and artificial intelligence generated claims consistent with the present disclosure.

FIG. 5C is an example knowledge graph structure rules diagram consistent with the schema from the data flow diagram of FIG. 5A for the identification and evaluation of both human and artificial intelligence generated claims consistent with the present disclosure.

FIG. 6 is a flowchart diagram depicting operations for the method for clinical quality measure analysis, on the distributed data processing environment of FIG. 1, consistent with the present disclosure.

FIG. 7 is a table of the study type of evidence consistent with the present disclosure.

FIG. 8 is a table of an agreement labels of claim evidence pairs consistent with the present disclosure.

FIG. 9 depicts a block diagram of components of the computing device executing the method for the identification and evaluation of both human and artificial intelligence generated claims within the distributed data processing environment of FIG. 1, consistent with the present disclosure.

### DETAILED DESCRIPTION

Proof of safety and trustworthiness is a difficult task, owing to its similarity with proving a negative, a philosophically impossible feat. For this reason, the approach to safety and trustworthiness evaluation must be exceptionally methodical. Acceptable evidence needs to be thorough and reproducible to approach proving the lack of a flaw in safety and trustworthiness. The disclosed system enhances the quality of human evaluation through automated analysis of user provided information in a thorough, reproducible, and well cited manner.

Disclosed herein is a system and method to automate the process of identification and assessment of claims. In an embodiment, the disclosed system is an agentic AI framework developed to enhance the evaluation of safety and trustworthiness in Clinical Quality Measures (CQMs). In effect, however, these CQMs may not always lead to improved healthcare quality. For example, measures that do not provide alternative service pathways for patients with barriers to receiving the intended treatments may lead to personalized care being categorized as low-quality care. Furthermore, the CQMs endorsement process for determining net benefit typically focuses on positive material outcomes of treatments compared to non-treatment, with less attention given to the potential harms or side effects of treatment, especially in patients populations with contraindications from comorbidities.

The disclosed system addresses the challenges of proving safety and trustworthiness, akin to proving a negative, by employing a methodical approach that ensures thoroughness and reproducibility. The disclosed system automates the assessment process, reducing costs and timelines while improving quality and interpretability. The system leverages the Claim Argument Evidence (CAE) framework and Assurance Case framework to construct and deconstruct claims, arguments, and evidence, minimizing human errors such as confirmation bias. Designed as an AI agent, the system utilizes large language models (LLMs) and tools like LangChain to automate evidence extraction, claim generation, and evaluation. This disclosure details the system methodology, including its input schema, ontology, and processes for evidence and claim evaluation.

One application of the disclosed system is the evaluation of health care CQMs. The goal is to identify and to assess the claims made in a measure document by a measure developer or steward and relate those claims to the context-mechanism-outcome (CMO) ontology of concepts and relations. Currently the identification and assessment of claims is a manual process that is both time and resource intensive. A novel component and distinct advantage of the disclosed system is an approach for guaranteeing that the system accurately pulls relevant citations.

For clarity, an illustrative example embodiment of the system for the evaluation of health care CQMs is described herein. It should be understood, however, that the methods, frameworks, and ontologies used by the disclosed system are informed by but not limited by this particular use case. The disclosed foundational framework was developed for effectively communicating complex relational concepts in safety and assurance. Under this framework, statements of truth called claims are supported by a body of trustworthy information called evidence through explicit relational statements called arguments. This framework also avoids a common pitfall of research literature where the claims and evidence are provided, but the explicit argument is left as an implicit exercise for the reader.

The risks posed by improper theoretical evaluation of the in-practice effects of CQMs highlight the need for robust evaluation processes. Currently this is a time and resource intensive manual process. Furthermore, traditional evidence-based assurance has been criticized as it is prone to confirmation bias, i.e., the tendency to retrieve, process, and interpret information in a manner that is consistent with existing beliefs. There exists a need to automate assessment, providing not only lower costs and timelines but also improved quality and interpretability through specially designed or selected methods, frameworks, and ontologies. These design choices simultaneously minimize contributions of human introduced errors such as confirmation bias by ensuring explicit, rather than implicit, evaluations of evidence, and gathering said evidence only by relevance, not by agreement.

Finally, to facilitate autonomous operation, the system is designed as an AI agent, since such systems have drastically improved the efficiency of literature reviews. The disclosed system centers around the idea of providing an LLM with tool descriptions and instructions for output formatting, then the LLM can effectively “choose” which tool to use for a given input. Tools are simply code functions with specific formatting requirements for the agent design library. For example, if an LLM is provided with a tool to search PubMed for an article, and a tool to search IMDB for movie synopses, when an input query is related to medicine, the system will “choose” to search PubMed, not IMDB. It is always worth noting that discussing the notion of choice for an LLM can be misleading, as it is simply that the most probable next sentence following the query (instructions, tool descriptions, and user input), is an answer formatted such that it represents a human choice.

LLMs are currently used to search for citations. LLMs are deep learning algorithms that can recognize, summarize, translate, predict, and generate content using very large datasets. LLMs are designed for natural language processing tasks such as language generation. The approach disclosed herein avoids a common pitfall of LLMs used alone (known as “hallucinations”) by using elastic search to query records, e.g., from a database, before interfacing with a generative natural language processing model, such as an LLM.

A primary function of the automation within the CAE framework is the collection of relevant evidence. For this purpose, the system must interface with a database of information, ideally peer-reviewed articles, journal publications, or otherwise trustworthy scientific information. Given the inclusion of some custom interface between the external database and the system, there are no restrictions on the database or set of databases used from a technical standpoint. Any interfacing functionality is required at minimum to allow searching by relevance to an input claim, though it could additionally implement more complex searching such as date range filtering.

In some embodiments, the disclosed system searches a database of scholarly articles to find relevant citations. One non-limiting example of such a database is the PubMed database. PubMed is a free, searchable bibliographic database from the National Library of Medicine (NLM) supporting scientific and medical research with more than 37 million citations and abstracts of biomedical and life sciences literature. It does not include full text journal articles; however, links to the full text are often present when available.

Although the example embodiment described herein under the example use case for CQM evaluation only interacts with one external database, i.e., the PubMed database, in other embodiments the disclosed system may interface with any information source with developer access such as an Application Programming Interface (API) or publicly accessible database. For example, other health care bibliographic sources could be used, such as Embase, CINAHL, Web of Science, and Scopus. Furthermore, information could expand beyond health care related sources. In fact, in other embodiments the disclosed system has used information from PubChem, UniProt, KEGG, arXiv, bioRxiv, and the U.S. patent database.

The disclosed system automates evaluation of both human and AI generated content. The system takes a document, an ontology, and a set of evidence as input and returns a structured assurance case for the claims made in that document. As used herein, an ontology refers to the systematic mapping of data to meaningful semantic concepts. Key to this assessment is the clear identification of claimed causality, and the evidence that supports these claims. The disclosed system can be used iteratively on LLM-created proposed measures or other LLM-generated content to create assurance through a generated, human inspectable, claim-argument-evidence assurance case. This allows for AI interpretation across domains, for example when using the qualities of a piece of evidence to evaluate a set of claims. Furthermore, for the disclosed system to effectively communicate information to users, an ontology also aids comprehension. Because the disclosed system requires structure to automate AI evaluation of information and requires the ability to communicate the complex concepts clearly, a well-defined and thorough ontology is created. The structure of the system ontology can be effectively conceptualized as a set of categorical label groups.

For each claim, the disclosed system identifies and assesses evidence and summarizes arguments. In some embodiments, the system uses natural language processing (NLP) to identify evidence that is related to the claim. In some embodiments, the system uses an LLM-powered AI agent to assess evidence and summarize arguments

In an embodiment, the system receives input documents that contain the following rules. The first field is importance, i.e., a person would claim. This indicates that a person or entity would make decisions based on the measure because the measure focus is associated with a material outcome.

The next field is validity, i.e., a person should claim. This indicates that there are known and effective ways of selection and choice that the person or entity should use. If a claim is for validity, then it may contain one or more sub-claims. The one or more sub-claims may be either association, i.e., there is an association between the person or entity response to the measure and the measure focus, and mechanism, i.e., there is an explicit articulation of the mechanisms (resources and response to those resources) responsible for the association.

The last field in this embodiment is usability, i.e., could claim. Any barriers or facilitators to whether the person or entity could use those ways are known and addressed.

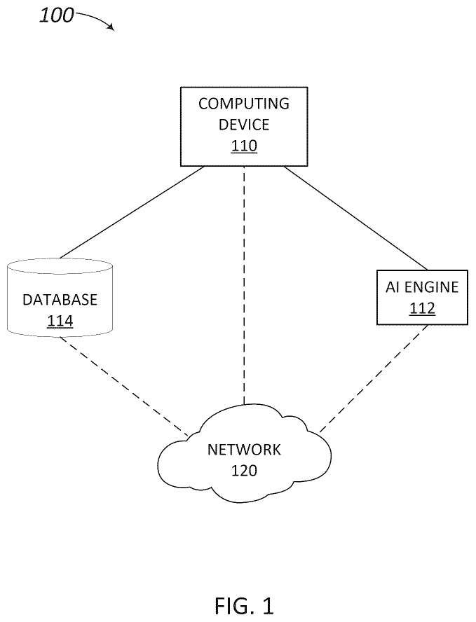

FIG. 1 is a functional block diagram illustrating a distributed data processing environment, generally designated 100, suitable for the identification and evaluation of both human and artificial intelligence generated claims consistent with the present disclosure. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the disclosure as recited by the claims.

Distributed data processing environment 100 includes computing device 110 optionally connected to network 120. Network 120 can be, for example, a telecommunications network, a local area network (LAN), a wide area network (WAN), such as the Internet, or a combination of the three, and can include wired, wireless, or fiber optic connections. In general, network 120 can be any combination of connections and protocols that will support communications between computing device 110 and other computing devices (not shown) within distributed data processing environment 100.

In an embodiment, computing device 110 can be a standalone computing device, a management server, a web server, a mobile computing device, or any other electronic device or computing system capable of receiving, sending, and processing data. In another embodiment, computing device 110 can represent a server computing system utilizing multiple computers as a server system, such as in a cloud computing environment. In yet another embodiment, computing device 110 represents a computing system utilizing clustered computers and components (e.g., database server computers, application server computers) that act as a single pool of seamless resources when accessed within distributed data processing environment 100.

In an embodiment, distributed data processing environment 100 includes AI engine 112. In some embodiments, AI engine 112 is located externally to computing device 110 and accessed through a communication network, such as network 120. In some embodiments, AI engine 112 is located on computing device 110. In some embodiments, parts of AI engine 112 may be located on computing device 110 while other parts of AI engine 112 may be located externally to computing device 112. In some embodiments, AI engine 112 may reside on another computing device (not shown), provided that AI engine 112 is accessible by computing device 110.

In some embodiments, AI engine 112 may include natural language processing (NLP), for example, to identify evidence that is related to the claim. In some embodiments, AI engine 112 may include an LLM, such as LLM-powered cognitive agents, for example, to assess evidence and summarize arguments.

In an embodiment, distributed data processing environment 100 includes database 114 communicatively coupled with the computing device 112. In some embodiments, the database 114 is located on computing device 110. In some embodiments, the database 114 is located externally to computing device 110 and communicatively coupled directly with computing device 110. In some embodiments, the database 114 is located externally to computing device 110 and accessed through a communication network, such as network 120. In some embodiments, the database 114 is located on computing device 110. In some embodiments, the database 114 may be the PubMed database maintained by the National Library of Medicine, a free, searchable bibliographic database supporting scientific and medical research which contains citations and abstracts of biomedical and life sciences literature.

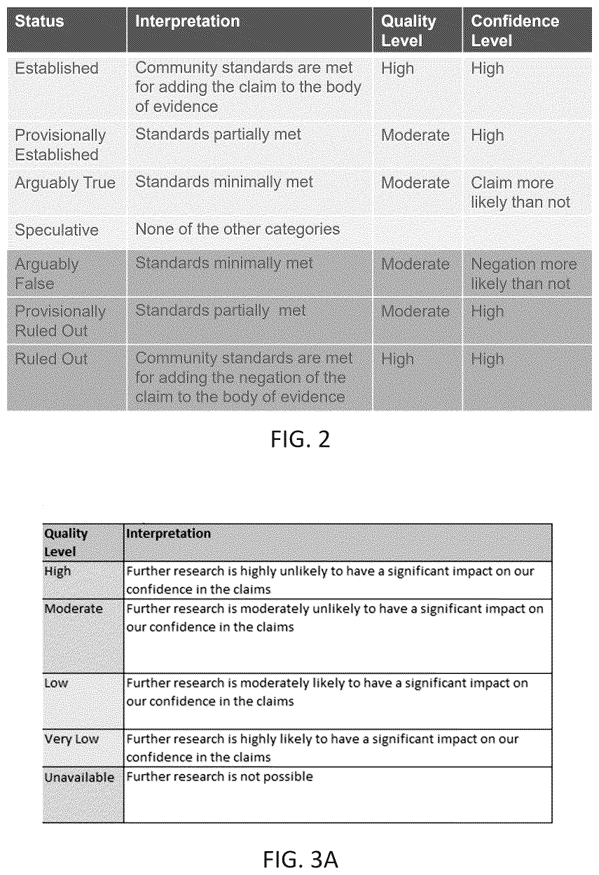

FIG. 2 is a table of a measure evaluation of a status of a claim for one illustrative example embodiment consistent with the present disclosure. The table in FIG. 2 shows the criteria for the status of a claim. As shown in the table of FIG. 2, the status of a claim may be “Established,” “Provisionally Established,” “Arguably True,” “Speculative,” “Arguably False,” “Provisionally Ruled Out,” and “Ruled Out.” For a status of “Established,” the claim must have an interpretation of “Community standards are met for adding the claim to the body of evidence,” with a quality level of “High” and a confidence level of “High.”

For a status of “Provisionally Established,” the claim must have an interpretation of “Standards partially met,” with a quality level of “Moderate” and a confidence level of “High.”

For a status of “Arguably True,” the claim must have an interpretation of “Standards minimally met,” with a quality level of “Moderate” and a confidence level of “ Claim more likely than not.”

For a status of “Speculative,” the claim must have an interpretation of “None of the other categories.”

For a status of “Arguably False,” the claim must have an interpretation of “Standards minimally met,” with a quality level of “Moderate” and a confidence level of “Negation more likely than not.”

For a status of “Provisionally Ruled Out,” the claim must have an interpretation of “Standards partially met,” with a quality level of “Moderate” and a confidence level of “High.”

For a status of “Ruled Out,” the claim must have an interpretation of “Community standards are met for adding the negation of the claim to the body of evidence,” with a quality level of “High” and a confidence level of “High.”

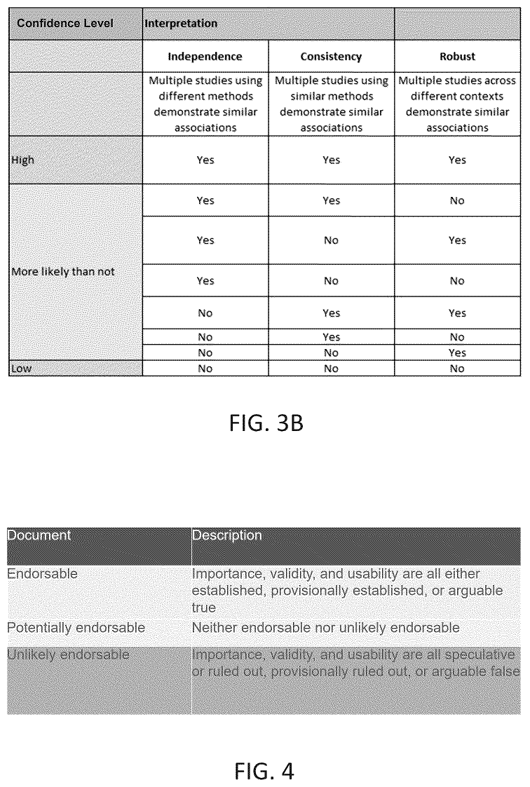

FIG. 3A is a table of a measure evaluation of quality levels of evidence for one illustrative example embodiment consistent with the present disclosure. The table in the illustrative example embodiment of FIG. 3A shows the criteria for the quality levels of the evidence. As shown in the table of FIG. 3A, the quality levels of the evidence may be “High,” “Moderate,” “Low,” “Very Low,” or “Unavailable.”

For a quality level of “High,” the evidence must have an interpretation of “Further research is highly unlikely to have a significant impact on our confidence in the evidence.”

For a quality level of “Moderate,” the evidence must have an interpretation of “Further research is moderately unlikely to have a significant impact on our confidence in the evidence.”

For a quality level of “Low,” the evidence must have an interpretation of “Further research is moderately likely to have a significant impact on our confidence in the evidence.”

For a quality level of “Very Low,” the evidence must have an interpretation of “Further research is highly likely to have a significant impact on our confidence in the evidence.”

For a quality level of “Unavailable,” the evidence must have an interpretation of “Further research is not possible.”

FIG. 3B is a table of a measure evaluation of the confidence level of evidence for one illustrative example embodiment consistent with the present disclosure. The table in the illustrative example embodiment of FIG. 3B shows the criteria for the confidence levels of the evidence. As shown in the table of FIG. 3B, the confidence levels of the evidence may be “High,” “More likely than not,” or “Low.” The confidence levels are determined based on three interpretations, “Independence,” “Consistency,” and “Robust.” For “Independence,” the criterion is whether multiple studies using different methods demonstrate similar associations. For “Consistency,” the criteria is whether multiple studies using similar methods demonstrate similar associations. For “Robust,” the criteria is whether multiple studies across different contexts demonstrate similar associations.

For a confidence level of “High,” the evidence must have an interpretation of yes for all three of “Independence,” “Consistency,” and “Robust.”

For a confidence level of “More likely than not,” the evidence must have an interpretation of yes for only one or two of “Independence,” “Consistency,” and “Robust.”

For a confidence level of “Low,” the evidence must have an interpretation of no for all three of “Independence,” “Consistency,” and “Robust.”

FIG. 4 is a table of a measure evaluation of endorsability of a document for one embodiment of the present disclosure. As shown in the table of FIG. 4, the confidence levels of the endorsability may be “Endorsable,” “Potentially endorsable,” or “Unlikely endorsable.” The description of “Endorsable” is “Importance, validity, and usability are all either established, provisionally established, or arguable true.” The description of “Potentially endorsable” is “Neither endorsable nor unlikely endorsable.” The description of “Unlikely endorsable” is “Importance, validity, and usability are all speculative or ruled out, provisionally ruled out, or arguable false.”

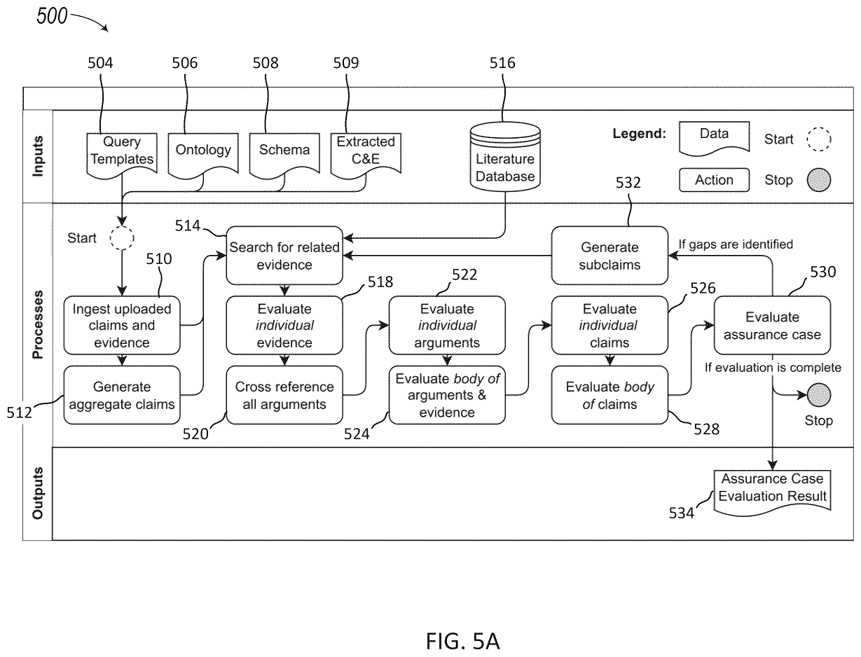

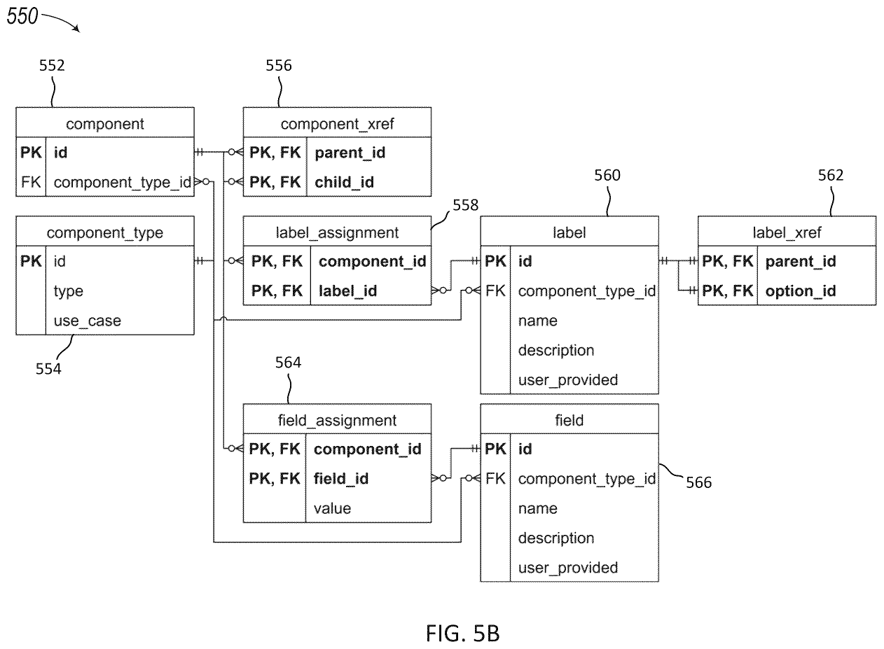

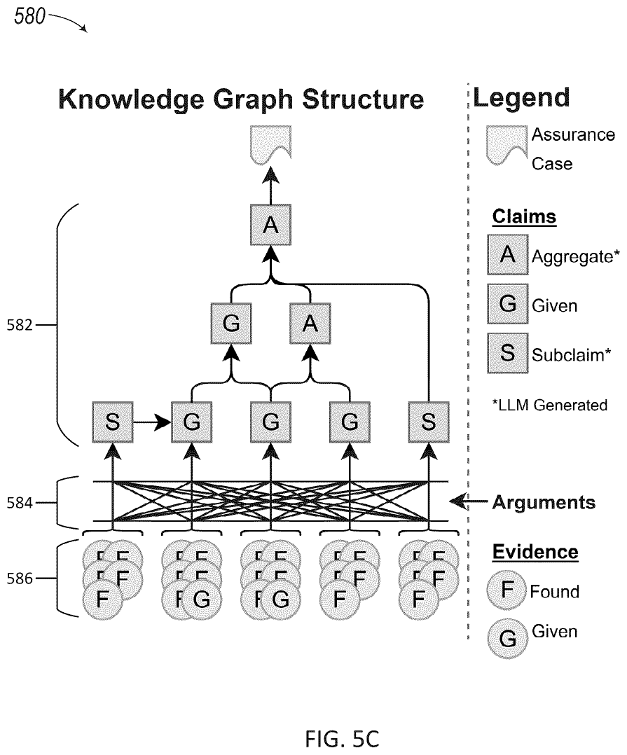

FIG. 5A is an example of data flow 500 for the identification and evaluation of both human and artificial intelligence generated claims consistent with the present disclosure. The data flow 500 starts by receiving one or more query templates 504, an ontology 506, a schema 508, and extracted claims and evidence 509. The information schema for the disclosed system is a set of relational statements between information domains. For example, the schema defines which ontological group is used to describe a particular piece of information. In the instance of the system for evaluation of CQMs, each label group is only applicable to one type of information: claim, argument, evidence, or overall assurance case document. These relationships are encoded within the schema. The clearest way to visualize the schema used for the system evaluation of CQMs is an entity relationship diagram, provided in FIG. 5B.

The query templates 504 serve as structured, reusable blueprints that define how user inputs are translated into LLM queries. They are designed to abstract the complexity of query formulation, enabling the AI agent to adapt to diverse user inputs while maintaining consistency and precision in information retrieval or task execution.

Each template typically includes intent mapping to link system goals to specific user inputs (e.g., claims), parameter slots for dynamic values extracted from user input or context, constraint logic to filter or refine results, and output expectations for formatting or structure of response. By treating query templates as inputs, the system gains flexibility and modularity, allowing for scalable adaptation to new domains, languages, or interaction patterns without altering the core agent logic.

An ontology 506 in knowledge-based systems is simply a formal description of shared knowledge in a domain. These descriptions enable LLMs to process information in a user defined fashion, for example when using the qualities of a piece of evidence to evaluate a set of claims. Furthermore, to effectively communicate information to users, the system requires ontologies to aid human comprehension. Because of these requirements, for each use case a well-defined and thorough ontology 506 is created to capture what is meant by “CAE Evaluation.”

The structure of the system ontology 506 can be conceptualized as a set of well-defined categorical label groups and free text fields. As the system generalizes across use cases, there are no predefined ontologies, and a particular use case's ontology 506 consists of a set of definitions for labels and fields related to a particular use case. To provide an example, the categorical label groups for the embodiment used for CQM evaluation, use case are as follows: Document Status, Claim Type, Claim Status, GRADE Rating, Agreement, Study Type, Confidence Level, and Quality Level. FIG. 2, FIG. 3A, FIG. 3B, and FIG. 4 all describe labels within the ontology for one illustrative example embodiment consistent with the present disclosure. A field, for example, is the Evidence Summary, or Justification. Typically, fields are designed to increase transparency and auditability of the LLM reasoning processes.

Further enabling generalizability, labels can be assigned by arbitrary methods, for example, manually by the user as part of the input document, by the AI-enabled system, or by other deterministic automated methods.

The system uses two primary information schemata. The first is a polymorphic data schema 508 for storage of all relevant information, and the second is an abstract knowledge graph structure used to conceptualize the information and process flow, such as knowledge graph 580 from FIG. 5C. The data schema 508 is simply a set of relational statements between information domains. For example, the schema defines that each instance of a label assignment can be related to one and only one component (e.g., claim, argument, evidence, or CQM submission). Furthermore, each component can have zero, one, or multiple related label assignments. These relationships among others are encoded within the schema. The definitive format to show the schema used for system evaluation in the an embodiment of the system used for CQM evaluation is an entity relationship diagram for the system database, provided in FIG. 5B.

This data schema 508 is designed to require minimal changes over the lifetime of the system. For example, you can see clearly component types (e.g., claims, arguments, etc.) have a particular use case. By adding more component types with new use cases to the component types table, the system can easily extend to a new use case without changing the schema. The data within a storage system pursuant to this schema for a specific assurance case catalogues all ontological inputs, all extracted claim and evidence inputs, and all outputs including evaluation results, arguments, and any generated claims or retrieved evidence. This systemic view of related data artifacts forms an instance of the next schema, the abstract knowledge graph.

The knowledge graph is a structured narrative framework that organizes the system reasoning into its core components: claims, which are assertions about the assurance case; arguments, which provide the logical connections between claims and supporting evidence; and evidence, which substantiates the claims. This is visualized in FIG. 5C with an exemplar knowledge graph 580 for an embodiment of the system consistent with the present disclosure. Evidence may be supplied directly by users (given) or discovered automatically by the system (found). Arguments can link multiple claims to multiple pieces of evidence, enabling rich many-to-many relationships that reflect complex reasoning. Claims themselves can be hierarchical, including user-provided base claims (given), system-generated claims that break down broader assertions (sub-claims), and aggregate claims synthesized from lower-level ones. This graph-based structure supports traceability, modularity, and automated analysis, making it a powerful tool for constructing and evaluating assurance cases.

The user submitted document for the system is the only input provided at runtime, all others are defined in advance. In abstract, the document is simply a collection of claims to be proven (or disproven), optionally associated with evidence. The user input format varies, but extraction and conversion to a standardized format is handled by a prior process, not within the scope of the present disclosure. The output of the prior process is the runtime input for the CAE Evaluation which this embodiment focuses on, the Extracted Claims & Evidence 509.

The storage of this data is ultimately arbitrary but in some embodiments of the system, to simplify use, the data is directly uploaded to a database conformant with the system input schema 508, such as schema 580. It should be noted that by design, the user does not submit explicit arguments. This decision lowers the barriers to use and aligns the tool with allowing literature evaluation where, as mentioned previously, explicit arguments are often absent (i.e., a claim statement with citation).

A primary function of the automation within the CAE framework is the collection of relevant evidence. For this purpose, the system must interface with a database 516 of information, ideally peer-reviewed articles, journal publications, or otherwise trustworthy scientific information. Given the inclusion of some custom interface between the external database and the system, there are no restrictions on the database 516 or set of databases used from a technical standpoint. Any interfacing functionality is required at minimum to allow searching by relevance to an input claim, though it could additionally implement more complex searching such as date range filtering.

Currently, under the illustrative example embodiment of a use case for CQM evaluation, the system interacts with one external database (PubMed), but in other embodiments the system may be configured to interface with any information source with some level of developer access such as an Application Programming Interface (API) or publicly accessible database. For example, other health care bibliographic sources could be used, such as Embase, CINAHL, Web of Science, and Scopus. Furthermore, information may expand beyond health care related sources.

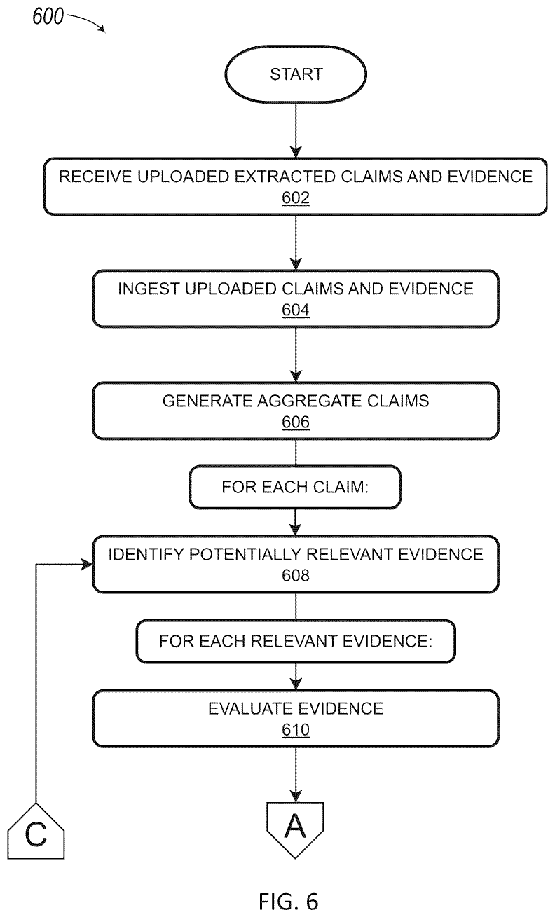

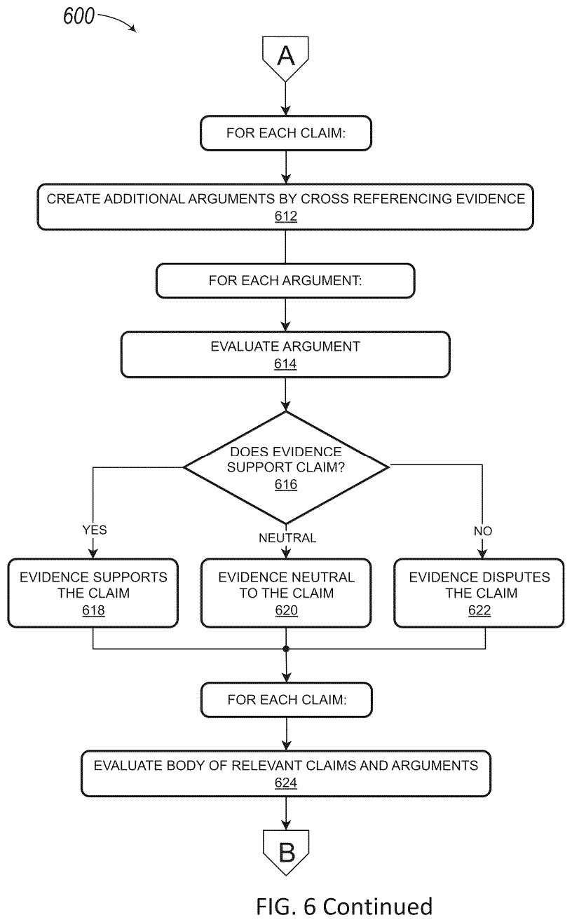

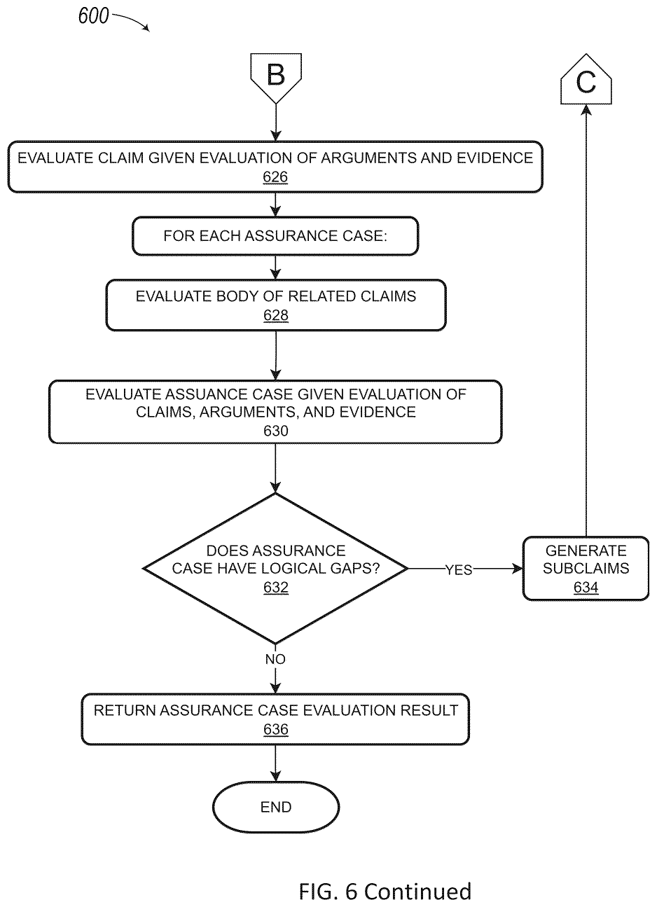

The operations in the processes section of data flow 500 are described in the flowchart of FIG. 6. These operations include ingest uploaded claims and evidence 510 (operation 604), generate aggregate claims 512 (operation 606), search for related evidence 514 (operation 608), evaluate individual evidence 518 (operation 610), cross reference all arguments 520 (operation 612), evaluate individual arguments 522 (operation 614), evaluate body of arguments and evidence 524 (operation 624), evaluate individual claims 526 (operation 626), evaluate body of claims 528 (operation 628), generate subclaims 532 (operation 634), and assurance case evaluation results 534 (operation 636).

FIG. 5B is an example schema diagram 550 from the data flow diagram of FIG. 5A for the identification and evaluation of both human and artificial intelligence generated claims for an embodiment of the system consistent with the present disclosure. The information schema for the disclosed system is a set of relational statements between information domains. The function of the various blocks in the schema diagram of FIG. 5B are explained below.

Block 552 is the component. This table stores the fundamental entities referred to as components. Each component is uniquely identified by an ID and is associated with a specific type through a foreign key component_type_id. This association determines the applicable labels and fields for the component. These fields may include an ID (Primary Key)—a unique identifier for the component, and a component_type_id (Foreign Key→component_type.id)—which references the type of the component, and which governs its classification and metadata schema.

Block 554 is the component_type, which defines the various types of components that can exist in the system. Each type includes a descriptive name and a use case, which guides the assignment of labels and fields. Examples of component types in the current iteration of the system are claim, argument, evidence, and assurance case, though the schema is not limited to these four types. The fields may include an ID (Primary Key)—a unique identifier for the component type, a type—a descriptive name of the component type, and a use_case—a name of the intended use or application of the component type for filtering. For example, “CQM Evaluation.”

Block 556 is the component_xref, which represents hierarchical relationships between components. Each record defines a parent-child relationship, enabling the modeling of nested components. The fields may include a parent (Foreign Key→component.id)—an identifier of the parent component, and a child (Foreign Key→component.id)—an identifier of the child component.

Block 558 is the label_assignment, which captures the assignment of categorical labels to components. Labels are selected based on the component's type and provide classification or tagging functionality. The fields may include a component_id (Foreign Key→component.id)—the component receiving the label, and a label_id (Foreign Key→label.id)—the label being assigned to the component.

Block 560 is the label. The label defines the set of available labels that can be assigned to components. Each label is associated with a component type and includes metadata such as name, description, and whether it must be user-defined. The fields may include an ID (Primary Key)—a unique identifier for the label, a component_type_id (Foreign Key→component_type.id)—which specifies the component type for which the label is valid, a name—the name of the label, a description—the description of the label's meaning or purpose, and a user_provided—a Boolean flag indicating whether the label must be provided by the user.

Block 562 is the label_xref, which defines relationships between labels to represent grouped label structures. This allows for complex categorization schemes. For example, the label “color” could be a group with 3 options “green”, “red”, “blue”. The fields may include a parent (Foreign Key→label.id)—an identifier of the parent label group, and one or more options (Foreign Key→label.id)—an identifier of one of the label options.

Block 564 is the field_assignment, which stores the assignment of textual or numeric values to components for specific fields. These fields provide detailed, user-defined, or system-defined metadata. The fields may include a component_id (Foreign Key→component.id)—the component to which the field value is assigned, a field_id (Foreign Key→field.id)—the field being assigned, and a value—the value assigned to the field for the given component.

Block 566 is the field which defines the set of fields that can be assigned to components. Each field is associated with a component type and includes metadata such as name, description, and whether it must be user-defined. For example, a field for an evidence type component would be “abstract.” The fields may include an ID (Primary Key)—a unique identifier for the field, a component_type_id (Foreign Key→component_type.id)—which specifies the component type for which the field is valid, a name-the name of the field, a description—a description of the field's purpose or content, and user_provided—a Boolean flag indicating whether the field must be provided by the user.

FIG. 5C is an example knowledge graph structure rules diagram 580 from the data flow diagram of FIG. 5A for the identification and evaluation of both human and artificial intelligence generated claims in an embodiment of the system consistent with the present disclosure. A knowledge graph is a particular instance of a structured framework that organizes the system reasoning into its fundamental components: claims 582, arguments 584, and evidence 586. Claims 582 are assertions made about the assurance case, arguments 584 provide the logical structure that connects claims to related evidence, and evidence 586 serves to support or dispute the claims. This structure enables traceability, modularity, and automated analysis, making it a powerful tool for constructing and evaluating assurance cases. The knowledge graph structure rules diagram 580 represents one possible knowledge graph.

Claims 582 are hierarchical and come in three types: given claims, subclaims, and aggregate claims. Given claims are provided directly by users. Subclaims are generated by the system to break down broader assertions. Aggregate claims are synthesized from multiple lower-level claims. Aggregate claims must have child claims, which can be given claims, subclaims, or other aggregate claims. Given claims may also have child claims, but only subclaims. Subclaims cannot have child claims and must be connected to a parent claim. In an embodiment, given claims, subclaims, and aggregate claims may be combined into a set of total claims.

Each claim 582 may be supported by evidence 586, which can either be given by users or found automatically by the system. Arguments 584 serve to link multiple claims to multiple pieces of evidence 586, allowing for complex many-to-many relationships that reflect the depth of reasoning within the assurance case. This graph-based approach ensures that all components are logically connected and that the reasoning behind the assurance case is both transparent and verifiable.

FIG. 6 is a flowchart diagram depicting operations for the process 600 for identification and evaluation of both human and artificial intelligence generated claims, on the distributed data processing environment of FIG. 1, consistent with the present disclosure. It should be appreciated that embodiments of the present disclosure provide at least for the identification and evaluation of both human and artificial intelligence generated claims. However, FIG. 6 provides only an illustration of one implementation and does not imply any limitations with regard to the environments in which different embodiments may be implemented. Many modifications to the depicted environment may be made by those skilled in the art without departing from the scope of the disclosure as recited by the claims.

Process 600 includes receiving one or more uploaded extracted claims (operation 602). In the illustrated example embodiment, the process 600 system receives a query template, an ontology, a schema, and one or more extracted claims and evidence as input.

Process 600 includes ingesting the uploaded claims and evidence (operation 604). Because parsing and storage of user inputs is handled prior to the CAE Evaluation module, ingestion is straightforward. Simply, each component in the database is queried, if it has already been fully evaluated, it is ignored, if it has not been fully evaluated, it is added to a list for the subsequent process steps to evaluate. Determination of evaluation status is also quite simple, if all required fields and labels are assigned, it is a fully evaluated component.

Process 600 includes generating aggregate claims (operation 606). The generation of aggregate claims is handled through prompt templates as described above in FIG. 5A. The children of these claims in the knowledge graph structure are either given, or other aggregate claims, and their purpose is to both increase interpretability of the information at a higher level of complexity by aggregating multiple atomic claims into a more complex claim, and for practical purposes to serve as token size reduction in evaluation of the assurance case. This is similar in theory to tree summarization methods used in LLM summarization tasks. For example, a prompt template may look like “Write a claim about {high_level_goal} based on {given_claims}” where any portion surrounded by braces (“{ }”) is a parameter slot that will dynamically be replaced by a high-level goal for each aggregate claim, and a list of relevant given claims. The claims generated are then handled the same as given claims in all subsequent process steps. In an embodiment, uploaded extracted claims, given claims, subclaims, and aggregate claims may be combined into a set of total claims.

Process 600 includes identifying potentially relevant evidence for each claim (operation 608). In the architecture of the disclosed system, the CAE Evaluation module is solely focused on initiating the retrieval and evaluating the evidence once it has been retrieved. The process of retrieving relevant evidence is handled by separate software components, ensuring a clear separation of concerns between data acquisition and reasoning. These components include technologies such as Elasticsearch, LLMs, and other natural language processing (NLP) techniques that specialize in indexing, searching, and interpreting unstructured or semi-structured data. Their role is to identify relevant evidence from reputable natural language sources like PubMed. This modular design allows the system to scale and adapt to different domains without changing the rigorous and transparent evaluation process. By decoupling retrieval from evaluation, CAES ensures that evidence is assessed objectively and consistently, regardless of how or where it was found.

Process 600 includes evaluating the evidence for each relevant evidence (operation 610). The first of many evaluation steps focuses on evidence. This process assigns all required fields and labels from the input ontology that are applied to evidence components. In other words, evaluation fully fills out a database entry for a piece of evidence. The evaluation is performed by a large language model agent provided with a tool to collect the evaluation results, and an input prompt template with all the necessary context to evaluate.

Aside from the agent tool description containing definitions for the required labels and fields, the agent is also provided with an evaluation context. The evaluation context can be any set of information interpretable by the large language model, including but not limited to plaintext, tabular data, vector embeddings, etc. The evaluation context used in the example case of CQM evidence evaluation is simply the PubMed article title and abstract in plain text. All the information is inserted within a prompt template, and the resulting prompt is used as the input to a language model. Then, the model output may be automatically parsed within, for example, LangChain using Pydantic (python software libraries) to perform validation on the expected evaluation fields and upload the results to the database.

Process 600 includes creating arguments by cross referencing the evidence for each claim (operation 612). This process identifies relevance relationships between all existing but not connected claims and evidence and initiates the creation of new argument components into the knowledge graph. This step is conceptually distinct from searching for related evidence described in operation 608, but it is performed by the same external software components responsible for evidence retrieval since determining relevance is inherently part of the retrieval process.

When a piece of evidence is found to be relevant to a claim, the system records this relationship as a new argument component. These relationships are not explicitly uploaded by the user but are inferred by the retrieval system based on semantic similarity, contextual alignment, or domain-specific heuristics. This design ensures that argument generation is both scalable and consistent with the system's modular architecture. By leveraging the same retrieval mechanisms for relevance detection and cross-referencing, the system maintains a unified pipeline from discovery to evaluation, while preserving the separation between data acquisition and reasoning.

Process 600 includes evaluating arguments for each argument (operation 614). The second evaluation step focuses on evaluating arguments which connect claims to related evidence. This process assigns all required fields and labels to all unevaluated arguments (i.e., unique combinations of claims and related evidence). Similarly to evidence evaluation, this process is performed by an LLM agent provided with a tool to collect the evaluation results, and an input prompt with all the necessary context for evaluation. Note that because an explicit argument is not uploaded by the user before evaluation an argument is simply a recognition of relevance between a claim and evidence. Therefore, in this case, the evaluation of the argument also includes the generation of a natural language argument. For example, each argument evaluation includes an agreement label (either agree or disagree), and the natural language justification for the assignment of that label, is itself the argument.

The argument evaluation context used in the example case of CQM evaluation is the content of the claim connected to the argument in question, the title and abstract of the relevant evidence, and all prior evaluation results assigned during evidence evaluation. The generation of LLM input, and automated parsing and upload of results is the same as described in operation 610 for evidence evaluation.

Process 600 includes comparing each evidence to the claim (decision block 616). The process 600 compares each evidence with the claim and the LLM determines whether it “supports”, “disputes”, or is “neutral” to the claim in question, as well as an argument that supports that conclusion. If the process 600 determines that the evidence supports the claim in question (“yes” branch, decision block 616), then the process 600 proceeds to operation 618. If the process 600 determines that the evidence is neutral to the claim in question (“neutral” branch, decision block 616), then the process 600 proceeds to operation 620. If the process 600 determines that the evidence does not support the claim in question (“no” branch, decision block 616), then the process 600 proceeds to operation 622. Note that while determining agreement is a fundamental aspect of process 600, the three outputs from decision block 616 are consistent with an embodiment of the system in the present disclosure and could change depending on the use case. For example, strongly agrees, weakly agrees, neither agrees nor disagrees, weakly disagrees, strongly disagrees, or irrelevant.

The claims along with the CAE structured evidence are returned to be addressed by the measure developer so the measure developer may update evidence or adjust claims, so they are congruent with the available evidence and argumentation.

Process 600 includes determining that the evidence supports the claim (operation 618). If the process 600 determines that the evidence supports the claim, then process 600 records the claim, the evidence, and the evidence that the evidence supports the claim in a results database. The process 600 then proceeds to operation 624.

Process 600 includes determining that the evidence is neutral to the claim (operation 620). If the process 600 determines that the evidence is neutral to the claim, then process 600 records the claim, the evidence, and the evidence that the evidence is neutral to the claim in the results database. The process 600 then proceeds to operation 624.

Process 600 includes determining that the evidence disputes the claim (operation 622). If the process 600 determines that the evidence disputes the claim, then process 600 records the claim, the evidence, and the evidence that the evidence does not support the claim in the results database. The process 600 then proceeds to operation 624.

Process 600 includes evaluating arguments for each argument (operation 624). Before a claim is evaluated, the CAE Evaluation module includes a critical intermediate step: the evaluation of the body of evidence and its associated arguments. This step occurs after individual pieces of evidence have been assessed and all arguments using those pieces have been evaluated. Its purpose is to identify emergent issues or patterns that may not be apparent when evaluating evidence or arguments in isolation.

The body-level evaluation considers the coherence, consistency, and completeness of the evidence set as a whole. For example, two pieces of evidence may individually appear valid but contain conflicting statements such as one asserting the effectiveness of a treatment while another reports statistically significant harm. Similarly, the system may detect an obvious gap, such as a piece of evidence about system reliability that lacks any of its own supporting evidence.

This evaluation is performed by an LLM agent using a structured prompt that includes all relevant evidence and argument evaluations. The agent is tasked with identifying contradictions, redundancies, and missing support, and labeling the body of evidence accordingly. These fields inform the subsequent claim evaluation, ensuring that claims are not assessed in isolation but in the context of the broader evidentiary landscape. In practice, this is created by adding a new “virtual” node in the knowledge graph which does not indicate a new piece of evidence but is treated similarly for convenience in the collection of evaluation context in subsequent steps.

Process 600 includes evaluating the claim given the evaluation of the arguments and the evidence for each claim (operation 626). The fourth evaluation step focuses on evaluating claims. Because the claims are hierarchical, the selection of the next claim to evaluate requires that all child claims in the knowledge graph structure have been previously evaluated. This process continues until all claims are evaluated. Claim evaluation assigns all required fields and labels to all claims. Similarly to evidence evaluation, this process is performed by an LLM agent provided with a tool to collect the evaluation results, and an input prompt with all the necessary context for evaluation.

The argument evaluation context used in the case of CQM evaluation is the content of the claim itself, all related arguments with their evaluation results, and all related evidence with their evaluation results. The generation of LLM input, and automated parsing and upload of results is the same as described in operation 610 for evidence evaluation.

Process 600 includes evaluating the body of the related claims for each assurance case (operation 628). Following the evaluation of individual claims, but prior to assessing the high-level assurance case, the CAE Evaluation module performs an intermediate evaluation of the body of claims. This step mirrors the approach described in operation 612 for evaluating a body of evidence and arguments, focusing instead on the coherence, alignment, and structural integrity of the claim hierarchy.

The body-level claim evaluation identifies issues such as redundant or contradictory claims, missing intermediate claims, or incoherent aggregation of sub-claims into higher-level assertions. For example, a top-level claim about system safety may be supported by sub-claims that are individually valid but collectively insufficient or misaligned in scope.

As with evidence, this evaluation is performed by a language model agent using a structured prompt that includes all relevant claim evaluations. The result is a synthesized assessment of the claim structure, captured in a “virtual” node within the knowledge graph. This node does not represent a new claim but serves as a container for context used in the final assurance case evaluation.

Process 600 includes evaluating the assurance case given the evaluation of the claims, the arguments, and the evidence for each assurance case (operation 630). The final evaluation step concerns the full suite of claims, arguments, and evidence related to a given assurance case. This process assigns fields and labels from the input ontology that are required for the assurance case component type. Similarly to evidence evaluation, this process is performed by an LLM agent provided with a tool to collect the evaluation results, and an input prompt with all the necessary context for evaluation.

The assurance evaluation context used in the case of CQM evaluation is the content and evaluation results of all relevant claims, arguments, and evidence. Note that to decrease the number of input tokens, the evidence abstract itself is not used. Rather, a generated field for the abstract summary is used. Having a summary of the evidence abstract in the results also increases interpretability for the end user. The generation of LLM input, and automated parsing and upload of results is the same as described in operation 610 for evidence evaluation.

Process 600 includes determining whether the assurance case has logical gaps (decision block 632). If the process 600 determines that the assurance case has logical gaps (“yes” branch, decision block 632), then the process 600 proceeds to operation 634. If the process 600 determines that the assurance case does not have logical gaps (“no” branch, decision block 632), then the process 600 proceeds to operation 636.

Process 600 includes generating subclaims (operation 634). Suppose a set of evidence has a clear gap, for example with an assurance case about smoking tobacco, the evidence may cover cigarette and pipe smoke but miss cigar smoke. In this case, we may want more claims and evidence to investigate the gaps in the current assurance case. In the evaluation of the full bodies of claims, arguments, and evidence as previously described, these gaps are catalogued. By searching through all generated descriptions of gaps, the system may now generate new claims which fill those gaps. The process 600 then returns to operation 608 to continue to identify potentially relevant evidence.

Process 600 includes returning the assurance case evaluation results (operation 636). After the input schema is fully populated through the prior ingest, discovery, generation, and evaluation steps, the only remaining task is to convert the information contained within the populated schema to a format for human interpretability. In the case of CQM evaluation, the process converts the content of a PostgreSQL database matching the input schema to an Excel workbook (xlsx file). This process consists of mainly merging tables, and formatting to maximize user interpretability.

Process 600 then ends for this cycle.

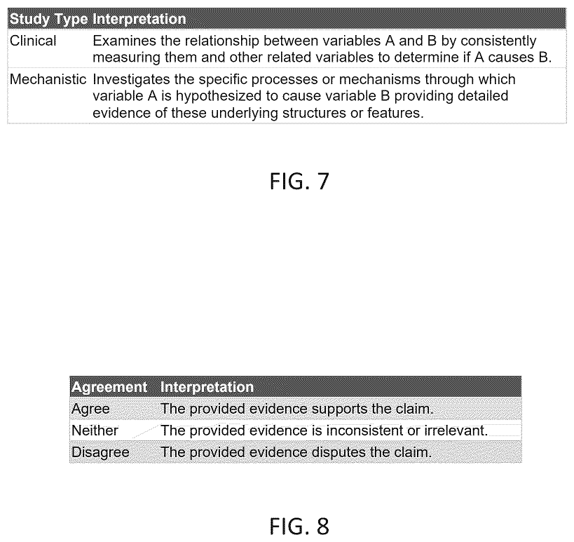

FIG. 7 is a table of possible study type evaluation results for a piece of evidence for one embodiment consistent with the present disclosure. As shown in the table of FIG. 7, the evidence may be a study of type “Clinical” or “Mechanistic.” The description of “Clinical” is “Examines the relationship between variables A and B by consistently measuring them and other related variables to see if A causes B.” The description of “Mechanistic” is “Investigates the specific processes or mechanisms through which variable A is hypothesized to cause variable B providing detailed evidence of these underlying structures or features.”

FIG. 8 is a table of an agreement evaluation of arguments for one embodiment consistent with the present disclosure. As shown in the table of FIG. 8, the argument pertains to the agreement between a claim and evidence with the type “Agree”, “Disagree”, or “Neither.” The description of “Agree” is “the provided evidence supports the claim.” The description of “Disagree” is “the provided evidence disputes the claim.” The description of “Neither” is “the provided evidence is inconsistent or irrelevant.”

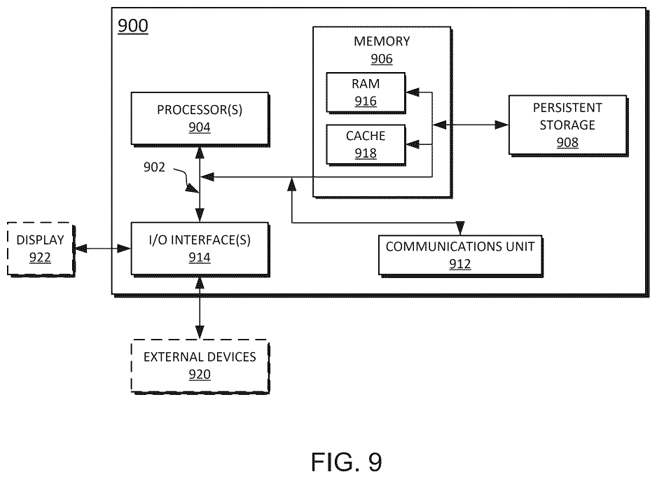

FIG. 9 is a block diagram depicting components of one example of the computing device 110 suitable for identification and evaluation of both human and artificial intelligence generated claims, within the distributed data processing environment of FIG. 1, consistent with the present disclosure. FIG. 9 displays the computing device or computer 900, one or more processor(s) 904 (including one or more controllers or computer processors), a communications fabric 902, a memory 906 including, a random-access memory (RAM) 916 and a cache 918, a persistent storage 908, a communications unit 912, I/O interfaces 914, a display 922, and external devices 920. It should be appreciated that FIG. 9 provides only an illustration of one embodiment and does not imply any limitations with regard to the environments in which different embodiments may be implemented. Many modifications to the depicted environment may be made.

As depicted, the computer 900 operates over the communications fabric 902, which provides communications between the computer processor(s) 904, memory 906, persistent storage 908, communications unit 912, and input/output (I/O) interface(s) 914. The communications fabric 902 may be implemented with an architecture suitable for passing data or control information between the processors 904 (e.g., microprocessors, communications processors, and network processors), the memory 906, the external devices 920, and any other hardware components within a system. For example, the communications fabric 902 may be implemented with one or more buses.

The memory 906 and persistent storage 908 are computer readable storage media. In the depicted embodiment, the memory 906 comprises a RAM 916 and a cache 918. In general, the memory 906 can include any suitable volatile or non-volatile computer readable storage media. Cache 918 is a fast memory that enhances the performance of processor(s) 904 by holding recently accessed data, and near recently accessed data, from RAM 916.

Program instructions for identification and evaluation of both human and artificial intelligence generated claims may be stored in the persistent storage 908, or more generally, any non-transitory computer readable storage media, for execution by one or more of the respective computer processors 904 via one or more memories of the memory 906. The persistent storage 908 may be a magnetic hard disk drive, a solid-state disk drive, a semiconductor storage device, flash memory, read only memory (ROM), electronically erasable programmable read-only memory (EEPROM), or any other computer readable storage media that is capable of storing program instruction or digital information.

The media used by persistent storage 908 may also be removable. For example, a removable hard drive may be used for persistent storage 908. Other examples include optical and magnetic disks, thumb drives, and smart cards that are inserted into a drive for transfer onto another computer readable storage medium that is also part of persistent storage 908.

The communications unit 912, in these examples, provides for communications with other data processing systems or devices. In these examples, the communications unit 912 includes one or more network interface cards. The communications unit 912 may provide communications through the use of either or both physical and wireless communications links. In the context of some embodiments of the present disclosure, the source of the various input data may be physically remote to the computer 900 such that the input data may be received, and the output similarly transmitted via the communications unit 912.

The I/O interface(s) 914 allows for input and output of data with other devices that may be connected to computer 900. For example, the I/O interface(s) 914 may provide a connection to external device(s) 920 such as a keyboard, a keypad, a touch screen, a microphone, a digital camera, and/or some other suitable input device. External device(s) 920 can also include portable computer readable storage media such as, for example, thumb drives, portable optical or magnetic disks, and memory cards. Software and data used to practice embodiments of the present disclosure can be stored on such portable computer readable storage media and can be loaded onto persistent storage 908 via the I/O interface(s) 914.

I/O interface(s) 914 may also connect to a display 922. Display 922 provides a mechanism to display data to a user and may be, for example, a computer monitor. Display 922 can also function as a touchscreen, such as a display of a tablet computer.

According to one aspect of the disclosure there is thus provided a system for identification and evaluation of both human and artificial intelligence generated claims, the system including: a computing device; an Artificial Intelligence (AI) engine; a database; and program instructions stored on a non-transitory storage device for execution by the computing device. The stored program instructions including instructions to: receive one or more measure documents; receive extracted claims and extracted evidence; create a set of one or more total claims from the received extracted claims; for each of the one or more total claims: identify potentially relevant evidence from the database using the AI engine; for each of the potentially relevant evidence: evaluate a quality and a confidence level; for each of the one or more total claims: determine whether each of the potentially relevant evidence supports each of the one or more total claims; evaluate a claim status for each individual claim of the one or more total claims based on the quality and the confidence level of the potentially relevant evidence, and whether the potentially relevant evidence supports the individual claim; and evaluate the one or more measure documents based on the one or more total claims related to the measure document and the claim status of each of the one or more total claims related to the measure document.

According to another aspect of the disclosure, there is provided a computer-implemented method for identification and evaluation of both human and artificial intelligence generated claims, the computer-implemented method including: receiving, by one or more computer processors, extracted claims and extracted evidence; ingesting, by the one or more computer processors, the extracted claims and the extracted evidence; creating, by the one or more computer processors, a set of one or more total claims from the received extracted claims; for each individual claim of the one or more total claims: identifying, by the one or more computer processors, potentially relevant evidence from a database; for each of the potentially relevant evidence: evaluating, by the one or more computer processors, a quality and a confidence level of the potentially relevant evidence; and determining, by the one or more computer processors, whether the potentially relevant evidence supports the individual claim; evaluating, by the one or more computer processors, a claim status for each individual claim of the one or more total claims based on the quality and the confidence level of the potentially relevant evidence, and whether the potentially relevant evidence supports the individual claim; and evaluating, by the one or more computer processors, one or more measure documents based on the one or more total claims related to the measure document and the claim status of each of the one or more total claims related to the measure document.

According to yet another aspect of the disclosure, there is provided a computer-implemented method for identification and evaluation of both human and artificial intelligence generated claims. The computer-implemented method includes: receiving, by one or more computer processors, one or more extracted claims and one or more extracted evidence; ingesting, by the one or more computer processors, the extracted claims and the extracted evidence; creating, by the one or more computer processors, a set of one or more total claims from the received extracted claims; for each of the one or more total claims: identifying, by the one or more computer processors, potentially relevant evidence from a database; for each of the potentially relevant evidence: evaluating, by the one or more computer processors, a quality and a confidence level of the potentially relevant evidence; for each of the one or more total claims: identifying, by the one or more computer processors, potentially relevant evidence; for each of the potentially relevant evidence: evaluating, by the one or more computer processors, the potentially relevant evidence; for each individual claim of the one or more total claims: creating; by the one or more computer processors; one or more arguments by cross referencing the potentially relevant evidence; for each individual argument of the one or more arguments: evaluating, by the one or more computer processors, each individual argument of the one or more arguments; determining, by the one or more computer processors, whether the potentially relevant evidence supports the individual claim; responsive to determining that the potentially relevant evidence does support the individual claim, recording, by the one or more computer processors, the individual claim, the potentially relevant evidence, and the evidence that the evidence supports the individual claim in a results database; responsive to determining that the potentially relevant evidence is neutral to the individual claim, recording, by the one or more computer processors, the individual claim, the potentially relevant evidence, and the evidence that the evidence is neutral to the individual claim in the results database; responsive to determining that the potentially relevant evidence does not support the individual claim, recording, by the one or more computer processors, the individual claim, the potentially relevant evidence, and the evidence that the evidence does not support the individual claim in the results database; evaluating, by the one or more computer processors, the individual claim based on the evaluation of the one or more arguments and the potentially relevant evidence for each individual claim; evaluating, by the one or more computer processors, an assurance case based on the evaluation of the one or more total claims, each individual argument of the one or more arguments, and the potentially relevant evidence for each assurance case; determining, by the one or more computer processors, whether the assurance case has one or more logical gaps; responsive to determining that the assurance case has the one or more logical gaps, generating, by the one or more computer processors, one or more subclaims; and responsive to determining that the assurance case does not have any logical gaps, returning, by the one or more computer processors, an evaluation result for the assurance case.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art. Also, it may be appreciated that the phraseology and terminology used herein is for the purpose of description and should not be regarded as limiting as such may be understood by one of skill in the art. Throughout the present disclosure, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The present disclosure may be a system, a method, and/or a computer program product. The system or computer program product may include one or more non-transitory computer readable storage media having computer readable program instructions thereon for causing a processor to carry out aspects of the present disclosure.

The one or more non-transitory computer readable storage media can be any tangible device that can retain and store instructions for use by an instruction execution device. The one or more non-transitory computer readable storage media may be, for example, but is not limited to, an electronic storage device, a magnetic storage device, an optical storage device, an electromagnetic storage device, a semiconductor storage device, or any suitable combination of the foregoing. A non-transitory computer readable storage media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from one or more non-transitory computer readable storage media or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in one or more non-transitory computer readable storage media within the respective computing/processing device.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, Field-Programmable Gate Arrays (FPGA), or other Programmable Logic Devices (PLD) may execute the computer readable program instructions by utilizing state information of the computer readable program instructions to personalize the electronic circuitry, in order to perform aspects of the present disclosure.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A system for identification and evaluation of both human and artificial intelligence generated claims, the system comprising:
a computing device;
an Artificial Intelligence (AI) engine;
a database; and
program instructions stored on a non-transitory storage device for execution by the computing device, the stored program instructions including instructions to:
receive one or more measure documents;
receive extracted claims and extracted evidence;
create a set of one or more total claims from the received extracted claims;
for each of the one or more total claims:
identify potentially relevant evidence from the database using the AI engine;
for each of the potentially relevant evidence:
evaluate a quality and a confidence level;
for each of the one or more total claims:
determine whether each of the potentially relevant evidence supports each of the one or more total claims;
evaluate a claim status for each individual claim of the one or more total claims based on the quality and the confidence level of the potentially relevant evidence, and whether the potentially relevant evidence supports the individual claim; and
evaluate the one or more measure documents based on the one or more total claims related to the measure document and the claim status of each of the one or more total claims related to the measure document.

2. The system of claim 1, wherein the program instructions further include:
generate one or more aggregate claims from the extracted claims; and
add the one or more aggregate claims to the set of one or more total claims.

3. The system of claim 1, wherein the AI engine is a generative natural language processing model.

4. The system of claim 1, further comprising:
a network, wherein the computing device, the AI engine, and the database are communicatively coupled via the network.

5. The system of claim 1, wherein the database is a PubMed database maintained by a National Library of Medicine.

6. The system of claim 1, wherein the quality of the potentially relevant evidence is selected from a first group consisting of high, moderate, low, very low, and unavailable.

7. The system of claim 1, wherein the claim status is selected from a third group consisting of established, provisionally established, arguably true, speculative, arguably false, provisionally ruled out, and ruled out.

8. The system of claim 1, wherein evaluate the one or more measure documents based on the one or more total claims and the claim status of each of the one or more total claims further comprises:
evaluate an endorsability of the one or more measure documents to determine an endorsability level, wherein the endorsability level is selected from a fourth group consisting of endorsable, potentially endorsable, and unlikely endorsable.

9. The system of claim 1, further comprising:
generate a claims-argument-evidence document.

10. The system of claim 1, wherein the one or more measure documents include provided evidence that is evaluated along with the potentially relevant evidence.

11. A computer-implemented method for identification and evaluation of both human and artificial intelligence generated claims, the computer-implemented method comprising:
receiving, by one or more computer processors, extracted claims and extracted evidence;
ingesting, by the one or more computer processors, the extracted claims and the extracted evidence;
creating, by the one or more computer processors, a set of one or more total claims from the received extracted claims;
for each individual claim of the one or more total claims:
identifying, by the one or more computer processors, potentially relevant evidence from a database;
for each of the potentially relevant evidence:
evaluating, by the one or more computer processors, a quality and a confidence level of the potentially relevant evidence; and
determining, by the one or more computer processors, whether the potentially relevant evidence supports the individual claim;
evaluating, by the one or more computer processors, a claim status for each individual claim of the one or more total claims based on the quality and the confidence level of the potentially relevant evidence, and whether the potentially relevant evidence supports the individual claim; and
evaluating, by the one or more computer processors, one or more measure documents based on the one or more total claims related to the measure document and the claim status of each of the one or more total claims related to the measure document.

12. The method of claim 11, further comprising:
generating, by the one or more computer processors, one or more aggregate claims from the extracted claims; and
adding, by the one or more computer processors, the one or more aggregate claims to the set of total claims.

13. The method of claim 11, wherein the database is a PubMed database maintained by a National Library of Medicine.

14. The method of claim 11, wherein the confidence level of the potentially relevant evidence is selected from a second group consisting of high, more likely than not, and low.

15. The method of claim 11, wherein the claim status is selected from a third group consisting of established, provisionally established, arguably true, speculative, arguably false, provisionally ruled out, and ruled out.

16. The method of claim 11, wherein evaluate the one or more measure documents based on the one or more total claims and the claim status of each of the one or more total claims further comprises:
evaluating, by the one or more computer processors, an endorsability of the one or more measure documents to determine an endorsability level, wherein the endorsability level is selected from a fourth group consisting of endorsable, potentially endorsable, and unlikely endorsable.

17. The method of claim 11, wherein the one or more measure documents include provided evidence that is evaluated along with the potentially relevant evidence.

18. The method of claim 11, wherein determine whether the potentially relevant evidence supports each claim further comprises:
determining, by the one or more computer processors, whether the potentially relevant evidence supports each individual claim, is neutral to each individual claim, or disputes each individual claim.

19. A computer-implemented method for identification and evaluation of both human and artificial intelligence generated claims, the computer-implemented method comprising:
receiving, by one or more computer processors, one or more extracted claims and one or more extracted evidence;
ingesting, by the one or more computer processors, the extracted claims and the extracted evidence;
creating, by the one or more computer processors, a set of one or more total claims from the received extracted claims;
for each of the one or more total claims:
identifying, by the one or more computer processors, potentially relevant evidence from a database;
for each of the potentially relevant evidence:
evaluating, by the one or more computer processors, a quality and a confidence level of the potentially relevant evidence;
for each of the one or more total claims:
identifying, by the one or more computer processors, potentially relevant evidence;
for each of the potentially relevant evidence:
evaluating, by the one or more computer processors, the potentially relevant evidence;
for each individual claim of the one or more total claims:
creating; by the one or more computer processors; one or more arguments by cross referencing the potentially relevant evidence;
for each individual argument of the one or more arguments:
evaluating, by the one or more computer processors, each individual argument of the one or more arguments;
determining, by the one or more computer processors, whether the potentially relevant evidence supports the individual claim;
responsive to determining that the potentially relevant evidence does support the individual claim, recording, by the one or more computer processors, the individual claim, the potentially relevant evidence, and the evidence that the evidence supports the individual claim in a results database;
responsive to determining that the potentially relevant evidence is neutral to the individual claim, recording, by the one or more computer processors, the individual claim, the potentially relevant evidence, and the evidence that the evidence is neutral to the individual claim in the results database;
responsive to determining that the potentially relevant evidence does not support the individual claim, recording, by the one or more computer processors, the individual claim, the potentially relevant evidence, and the evidence that the evidence does not support the individual claim in the results database;
evaluating, by the one or more computer processors, the individual claim based on the evaluation of the one or more arguments and the potentially relevant evidence for each individual claim;
evaluating, by the one or more computer processors, an assurance case based on the evaluation of the one or more total claims, each individual argument of the one or more arguments, and the potentially relevant evidence for each assurance case;
determining, by the one or more computer processors, whether the assurance case has one or more logical gaps;
responsive to determining that the assurance case has the one or more logical gaps, generating, by the one or more computer processors, one or more subclaims; and
responsive to determining that the assurance case does not have any logical gaps, returning, by the one or more computer processors, an evaluation result for the assurance case.

20. The computer-implemented method of claim 19, further comprising:
generating, by the one or more computer processors, one or more aggregate claims from the extracted claims; and
adding, by the one or more computer processors, the one or more aggregate claims to the set of total claims.
